(19) United States
(12) Patent Application Publication
(10) Pub. No.: US 2012/0054037 A1
(43) Pub. Date: Mar. 1, 2012

(54) System and Method for Consumer Engagement and Revenue Optimization

(76) Inventor: Stephanie L. Grossman, Santa Monica, CA (US)

(21) Appl. No.: 13/292,051

(22) Filed: Nov. 8, 2011

Related U.S. Application Data
(62) Division of application No. 11/411,066, filed on Apr. 25, 2006.
(60) Provisional application No. 60/674,745, filed on Apr. 25, 2005.
(60) Provisional application No. 60/675,772, filed on Apr. 28, 2005.
(60) Provisional application No. 60/761,840, filed on Jan. 25, 2006.
(60) Provisional application No. 60/772,770, filed on Feb. 13, 2006.

(51) Int. Cl. G06Q 30/02

(52) U.S. Cl. 705/14.64

(57) ABSTRACT

The invention is an apparatus and method that targets communications devices with content from service providers, third party content providers, sponsors, promotional partners and advertisers. The invention matches the content with communications device users using customer profiles or device usage profiles and transmits the content to communications devices over a wireless network, via the internet, or other means. The communications devices store the content in an internal repository. The content is later displayed as a result of triggers by designated users' actions. The content is displayed in the unused space of communications devices, between a designated user action and the actuation of an intended event or function. Media or content displayed when a triggering action occurs may be cached and stored in the repository or may be delivered in real time.

### CROSS REFERENCE TO RELATED APPLICATIONS

The present application for patent claims priority to provisional application Ser. No. 60/674,745 entitled “Method for Consumer Engagement and Revenue Optimization,” filed Apr. 25, 2005, Ser. No. 60/675,772 entitled “Method for Consumer Engagement and Revenue Optimization,” filed Apr. 28, 2005, Ser. No. 60/761,840 entitled “System for Deploying Targeted Content in White Space on Wireless Devices,” filed Jan. 25, 2006, and Ser. No. 60/772,770 entitled “System for Deploying Targeted Content in White Space on Wireless Devices,” filed Feb. 13, 2006, and all assigned to the assignee hereof and hereby expressly incorporated by reference herein.

### BACKGROUND OF THE INVENTION

1. Field of the Invention

The invention relates generally to the field of content (e.g., advertisements, media, promotions, etc.). More specifically, the invention relates to a system and method for displaying content on a communications device.

2. Description of the Related Art

Improvements in communications technologies have led to an increase in the number of products/offerings provided by service providers (e.g., cable providers, internet providers, telephone companies, etc.), device manufacturers, content providers and companies offering and/or enabling value added services. Service providers offer numerous products which might include: voice services; data services such as text messaging and multimedia messaging; location based services; and internet access. Service providers also offer entertainment and a variety of content such as games, ring-tones and streaming music/video. As voice revenue diminishes and service providers become increasingly reliant on customers' use of data services and consumption of content, these service providers are continuously searching for new revenue streams to augment the declining average revenue per user (ARPU).

Wireless devices have incorporated many improvements in wireless communication technologies. For example, traditional mobile phones now feature more memory, more processing capabilities and larger screens for the viewing of content. In order to maintain and/or increase market share and revenue, device manufacturers must integrate applications/features that increase ARPU for service providers. That is, service providers may choose to integrate applications/features that are a direct or indirect source of new revenues.

The communications industry has created stiff competition amongst service providers. That is, service providers must offer new content and access to content from third party providers in order to remain competitive in the marketplace. Furthermore, service providers must aggregate or develop content that matches the interests of their customers. Moreover, service providers must transform themselves into media companies and failure to do so may result in decreasing ARPU. The cost of providing increasingly sophisticated services and content may be offset if service providers increase ARPU. Hence, service providers must persuade their customers to use more of their products to remain viable.

Automation of business practices and procedures has led many organizations to implement a business model referred to as Customer Relationship Management (CRM). CRM enables organizations to effectively promote acquisition, retention and revenue optimization through the use of reliable systems, processes and procedures. CRM calls for the automation of basic business practices and the analysis of customer behavior and communication with customers through a variety of channels.

Service providers have long recognized the need to increase ARPU. One way to increase ARPU is through targeted, unobtrusive and engaging promotions and advertising. Content providers (e.g., advertisers, brands, marketers, promoters and media companies) have long recognized the mobile communications channel as a pervasive and powerful way of connecting with their desired consumers (i.e., consumers they want to reach). Content providers have been searching for an effective model by which mobile communications devices may become a new medium to reach consumers. The invention addresses these needs by providing a system and method that advances the art.

### SUMMARY OF THE INVENTION

The invention comprises a system and a method for consumer engagement and revenue optimization. The method provides for the display of content on a communication device as a result of user actions that are intended to trigger events on the device unrelated to the display of the content. The content displays as soon as the user's action is taken. The length of the display is determined by the time necessary to actuate the event and may be visible until the intended event has been actuated. In some cases, a user's action might trigger an event on another user's device. A repository exists whereby the user can intentionally access the content at the user's leisure. Some content, for example, a call to action or value proposition, might be available to a user for a limited period of time or require a response within a specified period of time. Users can interact with the content at the time it is displayed, thereby interrupting the intended event, or interact with the content as a result of accessing the content within the repository. Users can share content with others through various means; the repository is a means to facilitate user interaction which may involve mobile commerce.

The system comprises a network, a management platform, and a communication device. The management platform may function as the network center for the system. The management platform may host a computer system, a database and a server. The system may be configured to communicate with providers of content, promotional sponsors and advertisers, collectively, content providers, interne and service providers, and communications devices. The system may update the database and may also store content; the database may store information about content providers. Consistent with the CRM model, the database may also store data associated with individual users or communications devices. The database is continually updated as information about individual users becomes available. The server may execute program scripts and may transmit content to and from targeted communications devices. The server may also transmit information about communications device usage and user responses which, in turn, may trigger additional content to be transmitted to targeted communications devices. A communications network may transmit data between the management platform and the communications device.

The communications device may host software that facilitates storage and presentation of content received from the management platform. Content may also be transmitted through the service provider, directly from content providers' servers, platforms, etc. The content may be displayed in real time or stored for later use. The display of content on the communications device may be the result of a user's actions that are intended to trigger events on the communications device unrelated to the display of the content. The content may be displayed as soon as the user's action is taken. The length of the display is determined by the time necessary to actuate the event; the display is visible until the intended event has been actuated. In some embodiments, a user's action may trigger an event on another user's device. A repository may exist whereby the user can intentionally access the content at the user's leisure. Some content, for example, a call to action or value proposition, might be available to a user for a limited period of time or require a response within a specified period of time. Users can interact with the content at the time it is displayed, thereby interrupting the intended event, or interact with the content as a result of accessing the content within the repository. Users can share the content with others through various means; users can also engage in mobile commerce directly from the repository.

For example, a display of content may be triggered by a user who places a call on a targeted communications device; content may be displayed while the communications device processes the call on both the sending and the receiving ends. Other designated actions and functions include launching a web browser, launching an application, uploading or downloading content or information, sending an SMS or MMS message, opening of a clam shell style device, or turning a device on or off.

### BRIEF DESCRIPTION OF THE DRAWINGS

The exact nature of this invention as well as its objects and advantages will be readily understood upon consideration of the following specification as related to the attendant drawings wherein like reference numerals throughout the drawings indicate like parts, and wherein:

FIG. 1 illustrates a block diagram of a Digital Sidebar system according to an embodiment of the invention.

FIG. 2 illustrates a block diagram of the management platform shown in FIG. 1 according to an embodiment of the invention.

FIG. 3 illustrates a block diagram of the communications device shown in FIG. 1 according to an embodiment of the invention.

FIG. 4 illustrates a block diagram of the management platform shown in FIG. 2 according to an embodiment of the invention.

FIG. 5 illustrates an exemplary menu displayed on the communications device shown in FIG. 3 according to an embodiment of the invention.

FIG. 6 illustrates exemplary targeted content displayed on the communications device shown in FIG. 3 according to an embodiment of the invention.

FIG. 7 illustrates a flow diagram of a first exemplary method to increase a service provider's ARPU or content provider's revenue according to an embodiment of the invention.

FIG. 8 illustrates a flow diagram of a second exemplary method to increase a service provider's ARPU or content provider's revenue according to an embodiment of the invention.

FIG. 9 illustrates a flow diagram of a third exemplary method to increase a service provider's ARPU or content provider's revenue according to an embodiment of the invention.

### DESCRIPTION OF THE PREFERRED EMBODIMENTS

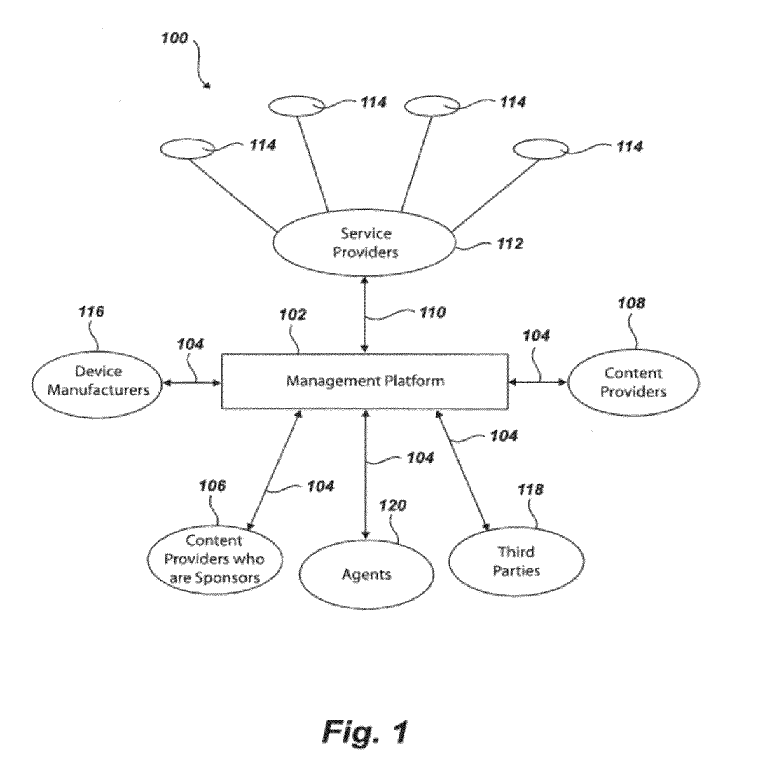

FIG. 1 illustrates a block diagram of a Digital Sidebar (DS) system 100 according to an embodiment of the invention. The management platform 102 functions as the nerve center of the DS system 100. The management platform 102 connects through the interne or other communication system 104 with content providers 108 and content providers 106 who are sponsors. The management platform 102 also connects with service providers 112 through, for example, a high bandwidth telephone line 110 (such as a T3 line), or other communication system (e.g., the internet). The content provider 108 or the service providers 112 may transmit data or content between the management platform 102 and the communications devices 114.

The internet 104 may provide the primary communications channel between the management platform 102, the content provider 108 and the service providers 112. However, telephone lines, power lines, cable, satellite and mail service may also be used. The high bandwidth telephone line 110 may provide the voice and/or data channel between the management platform 102 and the service providers 112. However, the internet 104 or a dedicated fiber, power line or satellite may be used. The management platform 102 may be co-located with the service providers 112 or embedded in the service providers' 112 computer systems; it may also be centralized with an ASP server 206 or a third party 118. The service providers 112 may communicate with the communications devices 114 through a wireless network or via the internet. However, alternate embodiments may feature wired networks with wired communications devices 114.

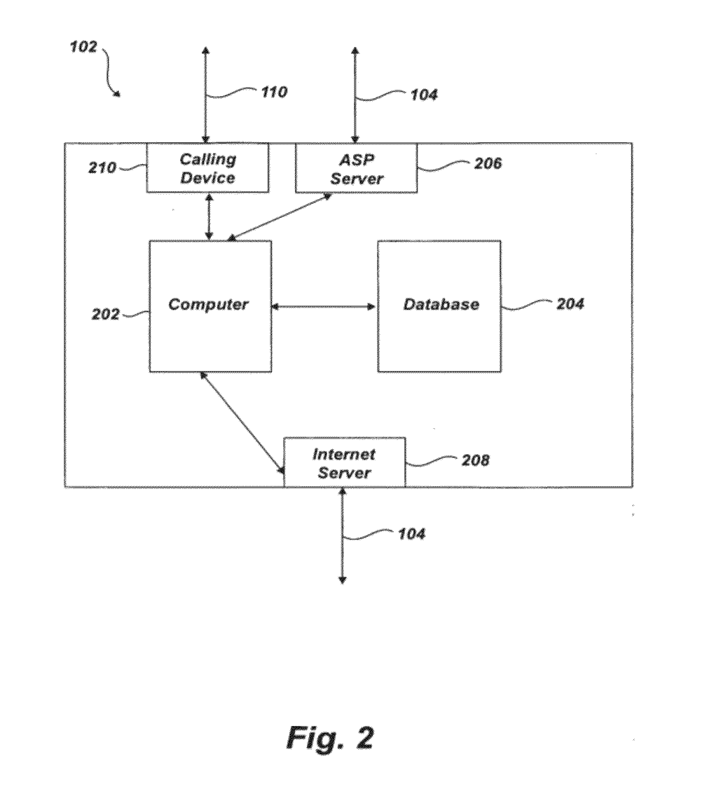

FIG. 2 illustrates a block diagram of the management platform 102 shown in FIG. 1 according to an embodiment of the invention. The management platform 102 may include a computer 202 which may have access to a database 204. The computer 202 may communicates with an ASP server 206 connected to the internet 104 and an internet server 208 also connected to the internet 104.

FIG. 2 illustrates the management platform 102 in a specific hardware topology according to an embodiment of the invention. However, many hardware and software topologies are contemplated. The computer 202, the database 204, the ASP server 206, the internet server 208 and the calling device 210 may be hosted on a single computational platform or may be distributed over any number of platforms. For example, the computer 202 may be used to receive content, run scripts, and send targeted content, thus performing the functions of the internet server 208, the calling device 210 and the ASP server 206. The devices may be co-located and communicate over a local area network or they may be distributed and communicate over a wide area network.

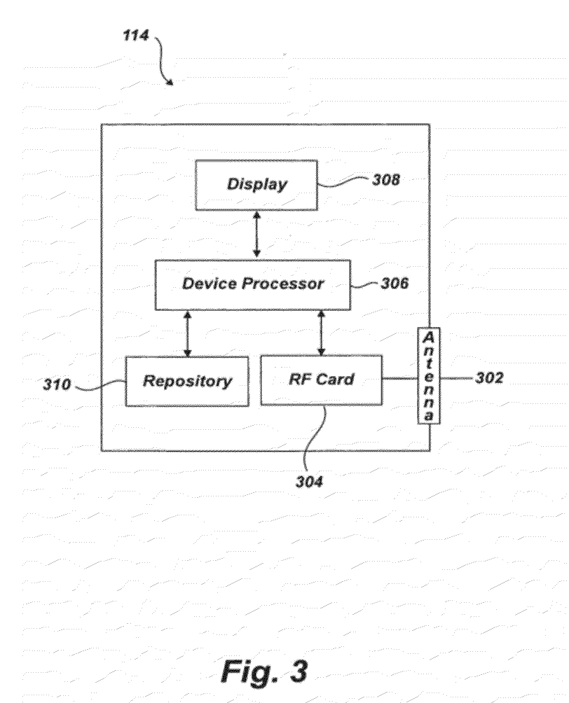

FIG. 3 illustrates a block diagram of a communications device 114 according to an embodiment of the invention. An antenna 302 may transmit and receive radio signals. An RF card 304 may convert the received radio signals from the antenna 302 into baseband signals to be processed by the device processor 306. The RF card 304 may also convert the baseband signals from the device processor 306 to modulated RF signals for transmission through the antenna 302. The device processor 306 may process the baseband signals and may drive a display 308 that displays content to a user. The device processor 306 may also manage a repository 310 where content may be deposited and/or stored for later use. The repository 310 may also serve as a portal for interaction with previously displayed content and related content, distribution of content to others, and mobile commerce.

The communications devices 114 may receive and transmit content through the bi-directional RF card 304 and the antenna 302. However, the communications devices 114 may be devices that are able to receive only such as televisions. The repository 310 may be flash memory, microprocessor cache, or any other type of memory storage device. The display 308 may comprise any type of display technology such as LCD, plasma, projection or picture tube. The use of devices, other than standard wireless devices such as mobile phones, Blackberries and Treos, is also contemplated. The DS system 100 may also be incorporated with personal computers, televisions, iPods and other devices with displays.

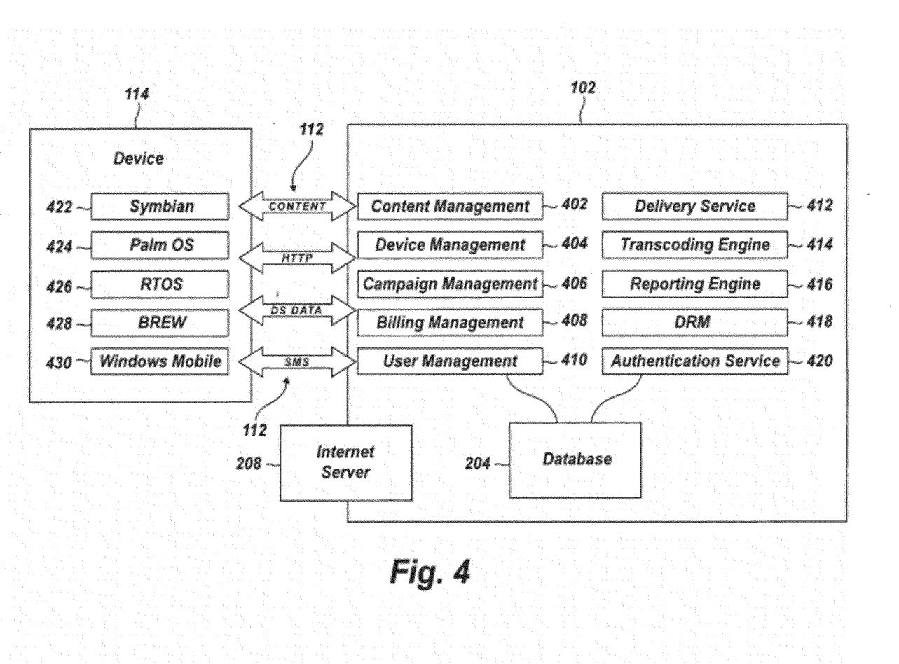

FIG. 4 illustrates some of the embedded functions of the DS system 100 according to an embodiment of the invention. The DS system 100 may be composed of the management platform 102 in communication with the communications devices 114 through the service providers 112.

A variety of software objects provide input, output, data processing, and data management features. A content manager 402 may receive content from the content providers 106 and 108. Alternatively, the content providers 106 and 108 may choose to transmit their content through their own platforms, an ASP 206 or through a third party 118 platform. A device manager 404 may track the individual communications devices 114, their configurations and capabilities, and the content sent to each of the communications devices 114. A campaign manager 406 may mine the database 204 for users to target for a promotional campaign, advertising campaign or other content, collectively, content. The campaign manager 406 may track demographic, psychographic, cybergraphic and geographic information of users; additional information such as the users' interests, responses to promotions, purchases and device usage may also be tracked. The campaign manager 406 may save the users' information in the database 204. The campaign manager 406 may use behavioral analytics, collaborative filtering or other means of predictive behavior modeling to target users. A billing manager 408 may track user purchases and the content providers 106 and 108 information for billing records. The billing manager 408 may use message sent metrics or response metrics to generate invoices. A profile manager 410 may update the database 204 to reflect user characteristics, attributes, response patterns and device usage. The profile manager 410 may update the database 204 using declared interests, gender, demographic, psychographic, cybergraphic and geographic information, credit history, responses to promotions, purchases or device usage. A delivery service 412 manager may manage the delivery of content to the communications devices 114. The delivery service 412 manager may determine the type of content, the protocol and may track the number of times content is sent to a particular communications device 114. A transcoding engine 414 may convert digital data into the appropriate data formats for data communication and data storage in the database 204. A reporting engine 416 may generate reports for delivery to the service providers 112, the content providers 106 and 108 or the campaign manager 406. A Digital Rights Manager (DRM) 418 may encrypt data and may manage policies, practices and procedures that properly manage data for the DS system 100. An authentication service 420 may provides data security for the content.

The management platform 102 functions may be automated or executed by individuals using a procedure set. In one embodiment, software objects provide most of the management platform functions. The software objects shown are exemplary and may be different in alternate embodiments. The DS system 100 may also be coded entirely using a functional architecture with no software objects.

The communications devices 114 may be enabling software that displays or stores content received from the management platform 102. The DS or similar software resident on the communications devices 114 may be coded using a variety of programming languages. A SIM card may be used to activate the DS system 100.

The management platform 102 may be used to implement a business model that is a combination of CRM and a sponsorship or advertising sales initiative (hereinafter MONETIZED CRM). In MONETIZED CRM, the service providers 112, content providers 106 and 108, or agents 120 for the service providers 112 may sell media placements to sponsors, advertisers, promotional partners or content providers, collectively, content providers 106 and 108. Media placements may include promotions, promotional messages, advertisements or content, collectively, content, transmitted to and displayed on the communications devices 114. The content providers 106 and 108 may offer goods, services, prizes, coupons, or other consideration to the service providers' customers, content providers' customers, device manufacturers' customers or other users in exchange for a fee paid to the service providers 112, the content providers 106 and 108, the device manufacturers 116 or agents 120 for the service providers 112, the content providers 106 and 108 or the device manufacturers 116. The service providers 112, the content providers 106 and 108, the device manufacturers 116, or agents 120 for the service providers 112, the content providers 106 and 108 or the device manufacturers 116 may transmit the media placement to the targeted users' communications devices 114. The media placement may be independent of or combined with a promotion from the service providers 112, the content providers 106 and 108, or the device manufacturers 116 to its customers.

As part of MONETIZED CRM, the service providers 112, the content providers 106 and 108, the device manufacturers 116, or a third party 118 may update the database 204. The database 204 may store customer and user data. For example, the database 204 may associate a customer's phone number or a device's ISDN number with purchases, downloads, internet-browsing and other behavior. Once enough data is gathered, behavioral analytics, predictive behavior modeling and/or collaborative filtering may be used to determine which content selection should be sent to the communications devices 114.

Common subscriber profiling (CSP) may be used to enhance the database 204. CSP information may be acquired through self reporting, polling and surveying and may be an aggregation of gender, demographic information, psychographic information, cybergraphic information, geographic information, behavioral pattern information, and lifestyle information. A customer profile may emerge from the accumulated data allowing the service providers 112, the content providers 106 and 108, the device manufacturers 116, or their agents 120 to more effectively target content.

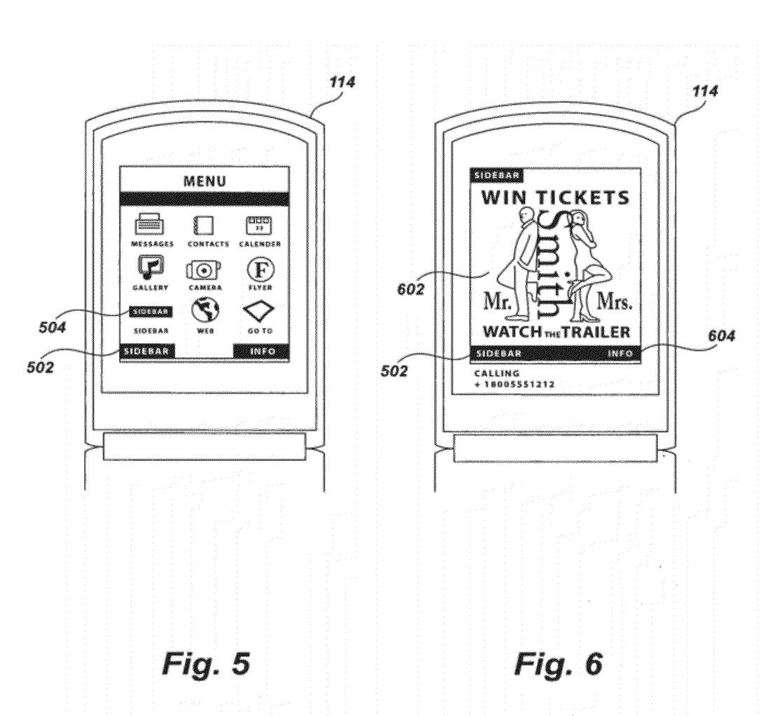

FIG. 5 illustrates an exemplary menu displayed on the communications device 114 shown in FIG. 3 according to an embodiment of the invention. The DS software, or other software which emulates the DS system 100 may be integrated into the operating system of the communications devices 114; a SIM card may also be used to emulate the DS system 100. A menu item 502 enables a user to access other menus that allow the user to select and display content stored in the repository 310. An icon or a soft key 504 on the display 308 of the communications device 114 may also provide access to the content.

Content available after selecting a menu item, an icon, or a soft key 504 may include information about goods and services offered, means by which to enter contests and promotions, personalized messages, content with embedded links to mobile portals, content with embedded links to the internet or WAP pages, interactive content and content with response mechanisms which enable a user to get data services or information from the service providers 112, the content providers 106 and 108 or the device manufacturers 116. There may be advertisements from sponsors 106 as well as a sponsor's 106 contact information. There may be menus or links that allow the user to communicate with the service providers 112, the content providers 106 and 108 or the device manufacturers 116 through the DS system 100. There may be a variety of goods and services displayed allowing the user to engage in mobile commerce. Additionally, users can share content made available through the DS system 100 with others. In one embodiment, a “share” function may allows content to be sent to others via SMS, MMS, email, links, etc.

FIG. 6 illustrates exemplary targeted content (e.g., a promotional advertisement) 602 displayed on the communications device 114 shown in FIG. 3 according to an embodiment of the invention. The user may select an options button or icon or a corresponding soft key 604 to display more information about the promotional advertisement 602. The user may also select the sidebar button, an icon, a menu item or a corresponding soft key 502 for more information about the content 602 or to access other content stored in the repository 310.

The display of the content 602 may be triggered as a result of or in response to a user's designated action that is intended to trigger events on the communications device 114 that are unrelated to the display of the content 602. The content 602 may be displayed as soon as the user's action is initiated or completed. The displayed content 602 may disappear automatically as soon as the intended event has been actuated. In some embodiments, the length of the display may be determined by the time necessary to actuate the event; the display may be visible until the intended event is actuated. In some embodiments, a user's action may trigger an event on another user's communications device 114. The repository 310 may exist so that the user can intentionally access the content 602 at the user's leisure. Some content, for example, a call to action or value proposition, might be available to a user for a limited period of time or require a response within a specified period of time. Users can interact with the content 602 at the time it is displayed thereby interrupting the intended event, or interact with the content as a result of accessing the content within the repository 310. If the user interacts with the content 602, it may be displayed until the user instructs the communications device 114 to remove the content 602 from being displayed.

Designated actions on the communications device 114 may include, but are not limited to, launch of a web browser, launch of an application, uploads and downloads of content, opening a clamshell phone, sending a short message service (SMS) or multi media message service (MMS) message, placing of a phone call which causes the call to be received by another user's communications device 114, and turning the communications device 114 on or off. The content 602 may be stored in the repository 310 and accessed at the leisure of users. The repository 310 provides a library of content allowing the users to review content that has been displayed on the communications device 114, and additional related content, at their leisure. The repository 310 also allows users to interact with content, connect to the internet, connect to a WAP portal, connect to related content, share content with others through SMS, MMS, email or other links; the repository 310 is a means to facilitate user interaction which may involve mobile commerce.

The content 602 may be pushed to or pulled by the communications device 114 via standard IP and existing data bearers such as GPRS, EDGE, UMTS, CDMA, EV-DO or via cell broadcast technology, SMS, MMS, WAP. The content 602 may also take the form of an audio announcement or audiovisual display and announcement.

The service providers 112 or the content provider 106 and 108 may bundle its products with the promotion or other content. For example, games, ring tones, photo services, streaming music and video, digital video and satellite broadcasts, music and video on demand, news, weather, sports and entertainment updates; increasing customers use of products and services offered by the service providers 112 or content providers 106 and 108 and encouraging future use.

It should be noted that FIGS. 1-6 describe various embodiments and that there are many other embodiments including systems wherein a proprietary client, e.g., software licensed from a third party is embedded in the software stack, chipset, or operating system of a communications device, and the proprietary client interacts with the native client, e.g., the software developed by the device manufacturer or original equipment manufacturer. Other examples might include software which is embedded or downloaded to the application layer or firmware of targeted devices which provides an environment of similar interactive and immediate functionality as if the software were interacting with the native client in the devices; a SIM card might also enable this functionality 114. In some of these embodiments, the software may trigger a visual or audio-visual display of content on the communications device 114 as a result of a user's designated actions that are intended to trigger actions or functions on the communications device 114 unrelated to the display of content; wherein the service providers 112, the content providers 106 and 108 or the third party 118, on behalf of the service providers 112 or content providers 106 and 108, may create the database 204 for storing customer related data; wherein the service providers 112, the content providers 106 and 108 or the third party 118, on behalf of the service providers 112 or the content providers 106 and 108, may maintain the database 204 for storing customer related data; wherein the service providers 112, the content providers 106 and 108 or the third party 118, on behalf of the service providers 112 or the content providers 106 and 108, may select a subset of the service provider's customers or the content provider's customers to receive a promotional announcement, advertisement or other content, collectively, content based on the customer-related data included in the database 204; wherein the service providers 112, the content providers 106 and 108 or the third party 118, on behalf of the service providers 112 or the content providers 106 and 108, may deliver content to a subset of the service provider's customers or the content provider's customers based on the customer-related data included in the database 204; wherein content 602 may be stored in the repository 310 within the communications device 114 and may be accessible to the user of the communications device 114; wherein content that may have been displayed on the communications device 114 may be stored in the repository 310 within the communications device 114 and may be accessible to the user of the communications device 114; wherein the repository 310 within the communications device 114 may provide a way for a consumer to contact the service providers 112 or the content providers 106 and 108 and may provide a means to request information about the content, goods, services and value propositions that have been delivered to the communications device 114; wherein the repository 310 within the communications device 114 may provide a way for a customer or user to enter contests, take advantage of value propositions offered by the service providers 112 or the content providers 106 and 108; and wherein the repository 310 within the communications device 114 may provide a way for a user to purchase goods, services or related content offered by the service providers 112 or the content providers 106 and 108 or other affiliated organizations; and wherein the repository 310 within the communications device 114 may provide a way for a user to link to additional content, information or services associated with the content stored in the repository 310; and wherein the repository 310 within the communications device 114 may provide a way for users to share content with others.

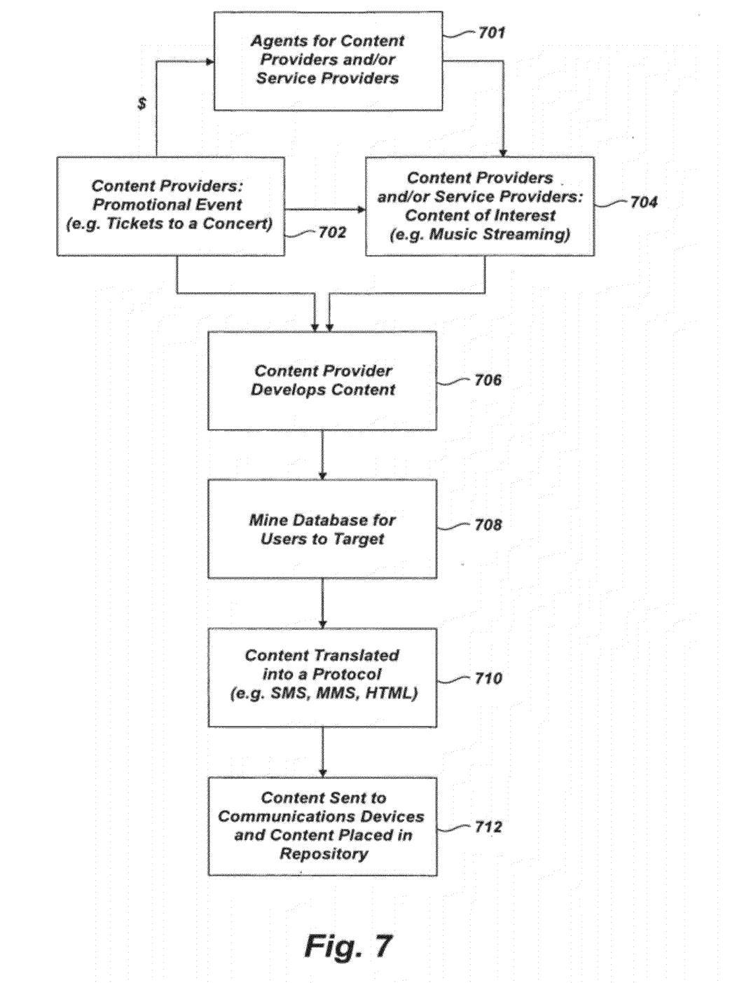

FIG. 7 illustrates a flow diagram of a first exemplary method to increase the service providers' 112 ARPU, the content providers' 106 and 108 revenues, or the device manufacturers' 116 revenues according to an embodiment of the invention. In step 702, the content providers 106 and 108 may sponsor a promotional event and pay money to the agents 120 (step 701), the service providers 112, the device manufacturers 116 or the content providers 108 to generate awareness about the promotional event. For example, to advertise a new music release the content providers 106 and 108 may want to offer a chance to win two free tickets with backstage pass to the concert of the artist who has recorded the new release. In step 704, the service providers 112 or the content providers 106 and 108 may have content to be advertised or promoted. For example, a service provider 112 may wish to advertise that availability of audio streaming over communications devices 114. In step 706, the content providers' 106 and 108 promotion or advertisement may be bundled with a sample of the service provider 112 or content providers' 106 and 108 contents. For example, a promotion may be developed and it may notify users or customers that they can win two tickets to the artist's concert with a backstage pass. A text line saying that free-streaming audio is available to the user and is sponsored by a music network or an athletic shoe company (the music network may be airing a live special of the artist and the athletic shoe company might employ the artist as a spokesperson). In step 708, the management platform 102 may mine the database 204 to find communications devices 114 of users to target. Users may be targeted based on demographic data, behavior profiles, actions that have occurred on the device or expressed interest. In step 710, the management platform 102 may convert the promotional content into digital format using data formats and protocols consistent with the communications devices 114 that have been targeted. In step 712, the promotions or advertisements may be sent to the communications devices 114 for immediate display or for placement in the repository 310 for display triggered as a result of users' designated actions on the communications device 114.

This method may increase ARPU for the service providers 112 because it may generate sponsorship or advertising revenue from the content providers 106 and 108 and because it may increase the likelihood that the communications device 114 users may expand their use of the content and data services offered by the service providers 112. In the above example, many users may choose to utilize the audio streaming features of their communications devices 114, thus increasing purchases of audio streaming and use of the service providers' systems resulting in revenues for the service providers 112 and the content providers 106 and 108 of streaming audio; users might also choose to share the content with others via MMS, SMS, email or other links which may increase the use of data services offered by the service providers 112. The device manufacturers' 116 revenue may be increased if they receive a percentage of the revenue resulting from advertising content that has been transmitted to the communications devices 114 in which they have integrated the DS software or a similar system. Targeting content based on related criteria or analytics may increase the likelihood that it will be relevant to the users who view it.

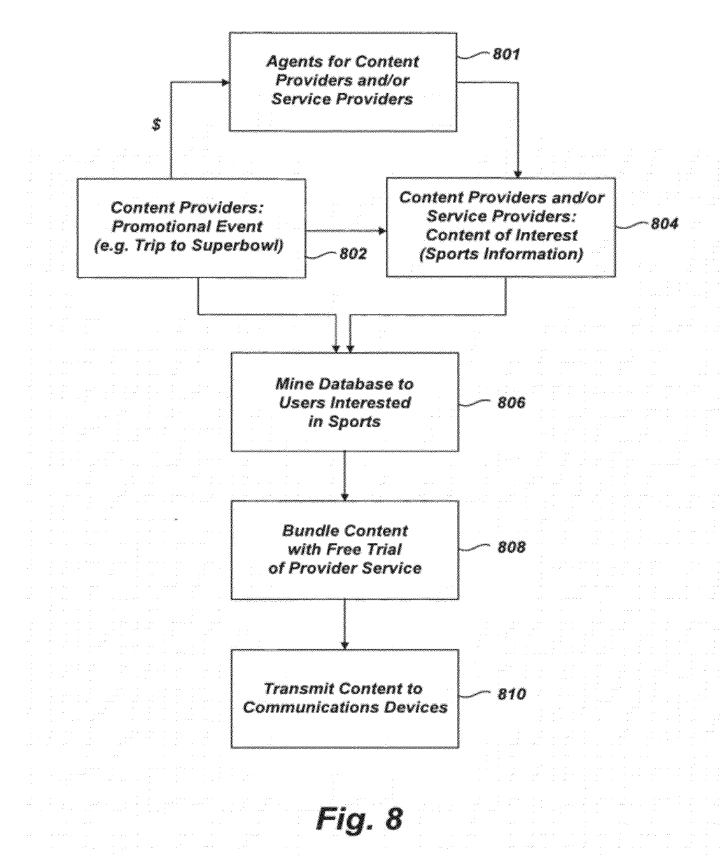

FIG. 8 illustrates a flow diagram of a second exemplary method to increase the service providers' ARPU, the device manufacturers' revenues and the content providers' revenues according to an embodiment of the invention. In step 802, the content provider 106 and 108 may have a promotional event it would like to advertise. For example, a sports league may want to advertise a drawing for a free trip to the playoffs and a credit card company that sponsors the sports league may want to participate in the promotional event; the credit card company may agree to provide gift checks to the winner of the trip and to sponsor the promotion. The credit card company may then pay the service provider 112 or the agent 120 for the service provider 112 (step 801) a fee for advertising the promotion. In step 804, the service provider 112 may identify relevant content or services that it may want to promote. In step 806, the service provider 112 or the agent 120 for the service provider 112 may mine the database 204 to search for users to target with the promotion. In step 808, a free trial period for the service provider's selected content may be bundled with the content provider's 106 and 108 promotion. For example, the service provider's customer who enters the drawing may receive a 60-day trial of the service provider's sports information updates. In step 810, the bundled promotion may be sent to the targeted communications devices 114.

This method may increase ARPU for the service provider 112 by exposing sports fans to its content, thereby increasing the chance that the customers who received the free content will buy similar content once the free trial ends; the service provider 112 also receives advertising revenue from the content providers 106 and 108. The content providers 106 and 108 also receive the added benefit of increased interest in the promotion since the targeted customers or users may be more interested in the sports updates than other customers or users. The device manufacturers' 116 revenues may be increased if they receive a percentage of the revenue resulting from advertising that has been transmitted to communications devices 114 that have integrated the DS software or a similar system. The content provider's 106 and 108 revenue may be increased when users purchase sports content available through their communications devices 114.

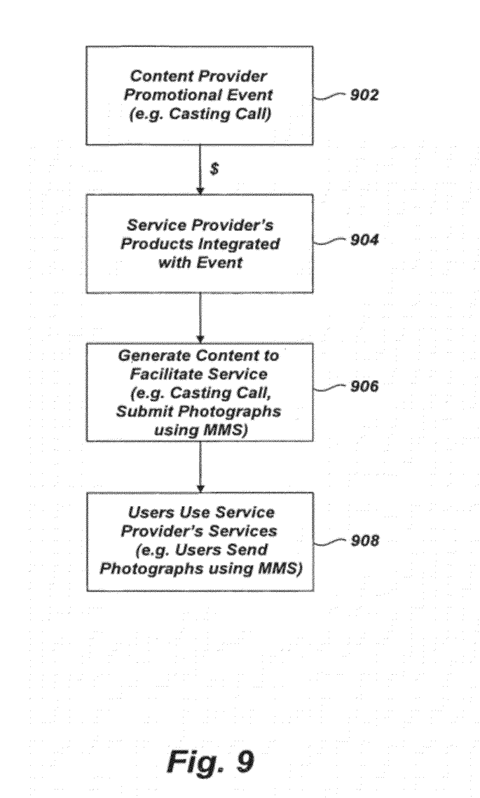

FIG. 9 illustrates a flow diagram of a third exemplary method to increase the service providers' ARPU, the device manufacturers' 116 revenues and the content providers' 106 and 108 revenues according to an embodiment of the invention. In step 902, the service providers 106 and 108 may want to increase use of MMS on the communications devices 114 and identifies a promotional event. The service providers 112 or the service providers' agents 120 may find a television studio that wants to promote a particular program. The television studio may sponsor a promotion for a casting call; customers can enter the promotion by sending their pictures via MMS on their communications devices 114. In step 906, the service providers 112 or the service providers' agents 120 may mine the management database 204 for the service providers' 112 customers who may be interested in the casting call; a promotional advertisement may be created to notify the users of the content providers' 106 and 108 event and how they may participate using their communications device 114 or alternative means. For example, the advertisement may say there is a casting call for young adults who have undiscovered talents and explain how to enter the casting call by sending their photographs using their communications device 114. In step 908, the user may send the photograph via MMS to enter the casting call.

This method may increase ARPU by generating advertising revenue for the service providers 112, as well as by increasing the use of the service providers' MMS services. In addition, the service providers' customers may become knowledgeable about the MMS data services available to them. This soft introduction to the service providers' 112 MMS service may generate revenue if the customer uses the MMS service in the future. The device manufacturers' 116 revenues may be increased if they receive a percentage of the revenues resulting from advertising that has been transmitted to communications devices in which they have integrated the DS software or a similar system. The content providers' (i.e., the studio) 106 and 108 revenues may be increased when the television show attracts more viewers; this may result in higher ratings and increased revenues from advertising sales. The studio might also sell content, associated with the television show, e.g., ring tones and graphics for the communications devices 114.

It should be noted that the methods described in FIGS. 7-9 are exemplary embodiments. Other embodiments include the variations, wherein multiple service providers 112 and/or content providers 106 and 108 are involved. The service providers 112 may receive revenues from the content providers 106 and 108 for the media placement and for transmitting the content to its customers or users; wherein the content that notifies the customer or user about the event, goods or services of the content provider 106 and 108 may be paid for by the content provider 106 and may include a promotion regarding goods and services offered by the service provider 112 or the content provider 106 and 108; wherein the event may be a contest or a promotion that includes a prize offered by the content provider 106 and 108 or its affiliates; wherein the event is a value proposition, e.g., prizes, free trials of goods or services, free goods, free services, coupons or discounts offered by the content provider 106 and 108 or the service provider 112; wherein the promotion may be an integrated marketing effort on behalf of the service provider 112 or the content provider 106 and 108 wherein the event offered by the service provider 112 or the content provider 106 and 108 may be a quiz or a game involving a dialogue with customers or users; wherein the service provider 112 or the content provider 106 and 108 may provide goods or services for free for a trial period to customers or users who receive the promotion; wherein the goods or services provided by the service provider 112 or the content provider 106 and 108 to the customer may be promoted by the content provider 106 and 108; wherein the service provider 112 or the content provider 106 and 108 or a third party 118 may create and maintain the database 204 for storing customer-related data; wherein the service provider 112 or the content provider 106 and 108 may select a subset of customers or users to receive the promotion based on the related data included in the database 204; wherein the service provider 112 or the content provider 106 or 108 may receive additional revenues from customers or users that use the goods and services beyond the end of the trial period; wherein the customer or user notifies others of the event, the others may contact the service provider 112 or the content providers 106 and 108 and may request new services, new products, information about products and/or services or may request that they be added to the database 204, and the service provider 112 or the content provider 106 and 108 may gain the opportunity to earn revenues from these customers; wherein the customer or user may notify others of the event and this results in viral marketing which ultimately increases the revenues for the service provider 112 or the content provider 106 and 108; wherein the service provider 112 may issue an announcement in other media or display formats regarding the event or the goods and services provided by the service provider 112 or the content provider 106 and 108; wherein the content provider 106 and 108 may issue an announcement in other media or display formats regarding the event or the goods and services provided by the content provider 106 and 108 or the service provider 112; (wherein the repository 310 for storing customer-related data may be embedded in a software stack included in the communications device 114; wherein the repository 310 for storing customer-related data may be embedded in a chipset included in a communications device 114; wherein the repository 310 for storing customer-related data may be embedded in an operating system, firmware, middleware or application layer of a communications device 114; wherein the repository 310 for storing content may be embedded in a software stack included in the communications device 114; wherein the repository 310 for storing content may be embedded in a chipset in a communications device 114; wherein the repository for storing content may be embedded in the operating system, firmware, middleware or application layer of a communications device 114.

1-14. (canceled)

15. A method for revenue optimization comprising:
receiving content from a content provider;
searching a database for a communications device;
sending the content to the communications device;
storing the content in a repository in the communications device; and
displaying the content on the communications device in response to an action by a user.

16. The method of claim 15 wherein the content is selected from a group consisting of an advertisement, media, a promotion, a call to action, and a value proposition.

17. The method of claim 15 wherein the action is selected from a group consisting of a launch of a web browser, a placing or receiving or ending of a phone call, a sending or receiving of an SMS or MMS, an opening of a clamshell communications device, a turning on or off of the communications device, and an uploading or downloading of the content.

18. The method of claim 15 further comprising storing the content in a repository for access at a later time.

19. The method of claim 15 further comprising interacting with the content and interrupting the action.

20. The method of claim 15 wherein displaying the content on the communications device is for a specified period of time.

21. The method of claim 15 further comprising sending the content from the communications device to a second communications device.

22. The method of claim 21 wherein sending the content from the communications device to a second communications device is performed using MMS, SMS or email.

23. The method of claim 21 wherein sending the content from the communications device to a second communications device is performed using GPRS, EDGE, UMTS, CDMA, EV-DO or WAP.

24. The method of claim 21 wherein the action by the user causes display of the content on the second communications device.

25. The method of claim 21 wherein the user interacts with the content using the communications device while or after the content is displayed on the display screen such that the interaction is selected from a group consisting of forwarding the content to the second communications device, accessing a video, an animation, a music file, a game, a graphic or a text, purchasing tickets, goods or services, placing a voice call, and sending a text message.

26. The method of claim 15 wherein the user interacts with the content using the communications device while or after the content is displayed on the display screen.

27. The method of claim 15 wherein the repository in the communications device may be selected from a group consisting of a flash memory, a cache and a memory storage device.

28. The method of claim 15 wherein the communications device requests information about the content from the management platform while or after the content is displayed on the display screen.

29. The method of claim 15 wherein the action by the user of the communication device is related or unrelated to the content.

30. The method of claim 15 wherein displaying the content on the display screen is in response to the user's action on the communications device that is related or unrelated to the user's action or the actuated function on the communications device.

31. The method of claim 15 wherein the user's action on the communications device causes an event to occur on a second communications device.

32. The method of claim 15 wherein the repository receives updated content while or after the communications device transmits data to the management platform.

33. The method of claim 15 further comprising transmitting data from the communications device to the management platform in response to the user interacting with the content on the display screen.

34. The method of claim 15 further comprising receiving data on the communications device in response to the user interacting with the content on the display screen.

35. The method of claim 15 further comprising conveying the content on the display screen in visual format, audio format or audio-visual format in response to a user's action requesting the content from the repository.

36. The method of claim 15 further comprising conveying the content on the display screen in visual format, audio format or audio-visual format between initiating the user's action and completing the user's action.

37. The method of claim 15 further comprising conveying the content on the display screen in visual format, audio format or audio-visual format until a user instructs the removal of the content.

38. The method of claim 15 further comprising:
storing updated content in the repository in the communications device; and
displaying the updated content on the communications device in response to an action which is independent of making a request to display the updated content.

39. A method of providing mobile commerce comprising:
storing content in a repository of a mobile communications device;
displaying the content on a display screen of the mobile communications device in response to a first action unrelated to requesting the content to be displayed between initiating the first action and completing the first action;
storing updated content in the repository of the mobile communications device;
displaying the updated content on the display screen of the mobile communications device in response to a second action which is independent of making a request to display the updated content between initiating the second action and completing the second action;
transmitting or receiving data in response to the user interacting with the content or the updated content that is displayed on the display screen; and
transmitting data about the mobile communications device related to usage or user responses.

40. A method of providing mobile commerce comprising:
receiving device data about a user's actions on a communications device;
receiving provider data from a wireless service provider about the communications device;
creating a user profile using the device data and the provider data;
identifying a plurality of communications devices to target based on the user profile;
transmitting targeted content to the plurality of communications devices; and
displaying the targeted content in response to a user-actuated function on the communications device.

41. A method of providing mobile commerce comprising:
receiving device data about a user's actions on a communications device;
creating a user profile using the device data;
identifying a plurality of communications devices to target based on the user profile;
transmitting targeted content to the plurality of communications devices; and
displaying the targeted content in response to a user-actuated function on the communications device.
